(19) United States
(12) Patent Application Publication
(10) Pub. No.: US 2024/0251932 A1
(43) Pub. Date: Aug. 1, 2024

(54) Backpack Safety Device

(71) Applicant: Joshua Berry, White Sulphur Springs, WV (US)

(72) Inventor: Joshua Berry, White Sulphur Springs, WV (US)

(21) Appl. No.: 18/425,401

(22) Filed: Jan. 29, 2024

Related U.S. Application Data
(60) Provisional application No. 63/441,876, filed on Jan. 30, 2023.

(51) Int. Cl. A45F 3/04; A45F 3/00; H04M 1/72409; H04M 1/72424

(52) U.S. Cl. CPC A45F 3/04; H04M 1/724094; A45F 2003/003; H04M 1/72424; H04M 2250/52

(57) ABSTRACT

A backpack safety device is disclosed to keep children safe by providing safety features that can be easily accessed. The backpack safety device comprises a body component that is configured in the shape of a conventional backpack. The body component comprises front and rear facing cameras, a microphone, a Teflon shield, an emergency alert button, and a communication button. The backpack safety device is also in wireless communication with a mobile application. The mobile application allows a user to view video from the cameras of the backpack device. The mobile application also has emergency contacts, which are notified when the communication button is pushed. The mobile application also allows a user to communicate with the user of the backpack device and can send Amber alerts if needed.

### CROSS-REFERENCE TO RELATED APPLICATION

The present application claims priority to, and the benefit of, U.S. Provisional Application No. 63/441,876, which was filed on Jan. 30, 2023, and is incorporated herein by reference in its entirety.

### FIELD OF THE INVENTION

The present invention relates generally to the field of backpack safety devices. More specifically, the present invention relates to a bulletproof child's backpack with video and audio recording using a front and rear camera. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in backpack safety devices. Generally, in today's society, children are often in vulnerable situations. Parents are uncomfortable not having a reliable method for monitoring their children. Further, in the event of an abduction, there is often little evidence to assist authorities. Additionally, GPS coordinates and video/audio feed could be used to save a life.

Further, kids carry a lot of books to school and they also carry laptops and tablets sometimes. Safety of the items carried is important and backpacks can provide them to some extent. However personal safety is also very important, if not more important, and backpacks today cannot provide them. Knife attacks on kids and shooting in schools make it clear that personal safety is always an issue and danger does lurk even in schools. There is a need for better bags that are more secure, and more convenient.

Accordingly, there is a demand for an improved backpack safety device that provides a bulletproof child's backpack with video and audio recording using a front and rear camera. More particularly, there is a demand for a backpack safety device that allows parents to monitor their child in real time using an accompanying mobile app.

Therefore, there exists a long felt need in the art for a backpack safety device that provides a bulletproof child's backpack with video and audio recording using a front and rear camera. There is also a long felt need in the art for a backpack safety device that includes GPS capabilities to alert parents via a mobile app of the child's location. Further, there is a long felt need in the art for a backpack safety device that enables users to contact emergency authorities and their parents with a push of the button. Moreover, there is a long felt need in the art for a device that allows parents to monitor their child in real time using the cameras and the accompanying mobile app. Further, there is a long felt need in the art for a backpack safety device that ensures that in an emergency or abduction, authorities are alerted immediately and footage of the incident exists. Finally, there is a long felt need in the art for a backpack safety device that can send Amber alerts if needed.

The subject matter disclosed and claimed herein, in one embodiment thereof, comprises a backpack safety device. The device is an improved backpack designed to keep children safe by providing safety features that can be easily accessed. The backpack safety device comprises a body component that is configured in shape of conventional backpack having a front panel, a back panel, opposing side panels, opposing top and bottom sections and a set of straps. The body component comprises front and rear facing cameras, a microphone, a Teflon shield, an emergency alert button, and a communication button. The backpack safety device is also in wireless communication with a mobile application. The mobile application allows a user to view video from the cameras of the backpack device. The mobile application also has emergency contacts, which are notified when the communication button is pushed. The mobile application also allows a user to communicate with the user of the backpack device and can send Amber alerts if needed. Further, a bulletproof insert may also be added to the interior of the device.

In this manner, the backpack safety device of the present invention accomplishes all of the forgoing objectives and provides users with a device that provides a bulletproof child's backpack with video and audio recording using cameras. The device is a backpack equipped with cameras, a microphone, and an emergency alert button. The device is also in wireless communication with a mobile application.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a backpack safety device. The device is an improved backpack designed to keep children safe by providing safety features that can be easily accessed. The backpack safety device comprises a body component that is configured in shape of conventional backpack with a plurality of safety features. The body component comprises front and rear facing cameras, a microphone, a Teflon shield, an emergency alert button, and a communication button. The backpack safety device is also in wireless communication with a mobile application. The mobile application allows a user to view video from the cameras of the backpack device and communicate with the wearer of the backpack safety device.

In one embodiment, the backpack safety device, as disclosed, is a backpack for carrying school books by kids and travel items by travelers, wherein the backpack safety device provides a Teflon shield and bulletproof insert and several sections for storing books and electronic items. It also provides other safety features, such as remote alerting and data collection capabilities based on cameras, communication buttons, speakers, microphone, and wireless communication with a mobile application, etc. Generally, it should be recognized that the backpack safety device can incorporate a large number of different safety features depending on the specifics of how the backpack is to be used. For purposes of this disclosure, the important aspect is that the backpack safety device serves as a locator of the associated user and will generally be used to allow the associated user to contact emergency services, when needed and alert a user of the mobile application that a threatening situation is occurring.

In one embodiment, the backpack safety device comprises a body component that is configured in the shape of a conventional backpack and defines a storage volume. Further, the body component comprises a front panel, a back panel, opposing side walls, opposing top and bottom sections and a set of straps. Further, the body component can include a front pocket section for storing pens, keys, tickets, etc., a front top section to store small electronics, wires, cables etc., and a main section with a zippered opening to store laptops, tablets, powerbank chargers, etc. In one embodiment, the outer panels and walls comprise a slash resistant material layer, such as a Teflon shield. Thus, the items inside the backpack safety device are not easy to steal by pickpockets and thieves who often try to silently make a cut or tear in the bag without the traveler/user noticing it. The body component also comprises pouches to safely and securely store a mobile device, a camera, a laptop, etc.

In one embodiment, the backpack safety device also comprises a powerbank portable charging device, wherein the powerbank portable charging device supplies power from its built-in batteries through a plurality of ports and attached charging cables (USB ports for example). Although the present invention has been described in terms of USB based power charging of devices, other forms and techniques to charge electrical devices such as mobile phones and cameras are also contemplated.

In one embodiment, the backpack safety device also provides a communication and location circuitry that not only determines a location (such as GPS location) but also communicates backpack status, powerbank portable charging device charging status, environmental conditions (such as heat, moisture, etc.) of the body component status etc. Accordingly, the communication and location circuitry reports the status of the backpack safety device, wherein the status comprises environmental conditions, the wear and tear effect/estimated, the number of ballistic shots the backpack safety device may have received, the time and location of when and where such ballistic shots might have been received, approximate impact location of the ballistic shots on the backpack safety device, etc. Using near field communications, WIFI, infrared (IR) and cellular means, the communication and location circuitry reports the status of the backpack safety device. For example, using NFC means the backpack safety device reports to a mobile device of the user the status of the backpack safety device. Further, the communication and location circuitry draws electrical power as necessary from the powerbank portable charging device to which it is electrically and communicatively coupled.

In one embodiment, the backpack safety device comprises at least one camera secured to the body component. The cameras can be positioned on the front and/or the back of the backpack safety device. The cameras are built-in to capture and communicate photos, audio and live streaming videos, as necessary. Such communication from cameras is through wireless means, wired means or both, based on needs and conditions. Several other locations for additional cameras are also contemplated, such as cameras on the backside, cameras inside, cameras on the sides, etc. Not all cameras need to be active at any given time. Data collection using these cameras is triggered by user actions, by voice commands by the user, by remote activation, etc. Further, the communication and location circuitry is coupled to the one or more cameras attached to the backpack safety device and helps communicate photos, audio data collected, and videos when the cameras are activated for data collection. Such cameras are attached to the front side, the backside and other places on the backpack safety device, as desired. The communication and location circuitry communicates GPS coordinates of the backpack safety device, along with data collected by these cameras. Data collection is triggered by monitoring circuitry in some configurations and upon user instruction in some others. The cameras can be initiated by remote triggers in some configurations.

In one embodiment, the back panel covers and protects the entire backside of the backpack safety device, end-to-end. In one embodiment, the back panel comprises a bulletproof insert, that may be added to the interior of the body component. The bulletproof insert comprises a main covering within which a plurality of ballistic resistance plates are provided. Together, these ballistic resistance plates protect the user of the backpack safety device and a portion of the user's body covered by the backpack safety device is protected from serious harm from ballistic shots. Accordingly, when worn on the backside of a user, the back panel protects the backside of the user. When worn across the user's chest, the back panel protects the front side of the user. In other embodiments, multiple bulletproof inserts can be provided for the interior of the body component, depending on the wants and/or needs of a user.

In one embodiment, the communication and location circuitry is incorporated into the back panel of the body component in some configurations, incorporated into the powerbank portable charging device (also referred to as the powerbank charger) in other configurations, and into the construction of the backpack safety device, itself, in yet other configurations.

In one embodiment, the backpack safety device comprises at least one speaker and microphone, which allow the user to communicate with a user of a synced mobile application, in real time. Further, the powerbank charger in the backpack safety device records and stores (such as for live transmission, sharing or backup), sounds collected, photos and videos from the connected cameras, speakers and microphone. The powerbank charger in the backpack safety device also communicates and/or stores photos and videos collected from a mobile phone, photos and videos from the connected camera(s), and photos and videos from the connected tablet device. For example, the powerbank charger comprises memory, storage and communication circuitry that enables it to receive and store all photos and videos transferred/communicated by the connected cameras, mobile phone, tablet, and camera(s) that it is currently connected to. It is capable of sharing such transferred photos and videos with websites, video servers, social groups, social networks, YouTUBE network, Facebook network, etc. It is capable of uploading transferred photos and videos with Google websites, Google photos network, etc. The devices (camera, mobile phone, tablet, etc.) can then automatically delete those transferred photos and videos thereby making more memory/storage available for additional photos, data, videos, etc.

In one embodiment, the electronic circuitry of the backpack safety device comprises a processor communicatively coupled to a communications circuitry, wherein the communications circuitry is capable of NFC and wifi communications for communicating data collected and streaming videos (such as those taken by a camera communicatively coupled). In another embodiment, the processor is communicatively and electrically coupled to the powerbank charger for electrical power. The processor facilitates near-field and wifi communications employing the communications circuitry, conducts automated and triggered mode monitoring, and data collection.

In one embodiment, the backpack safety device comprises an emergency alert button and a communication button. Pressing the emergency alert button, contacts emergency services, such as police, fire, EMT, etc. The user hits the emergency alert button, i.e., when an attacker or threatening person approaches, in the event of a threatening situation, or when the user has a health emergency. Pressing the communication button allows the wearer of the backpack safety device to communicate with the user of the synced mobile application. Further, emergency contacts can be listed, which are notified when the communication button is pushed. A user can also send Amber alerts, if needed. Furthermore, the backpack safety device also comprises audio command circuitry that monitors audio signals from the speakers to detect commands and instructions, and upon detecting, triggers a corresponding activity, instead of having the user push a button. For example the user of the backpack safety device may say “alert” and the backpack safety device responds by detecting “alert” to be a command and initiates contacting emergency services. For a different example, other similar user commands that initiate calling a local police or fire for help, such as “danger”, “help”, “police”, etc., can be utilized, as needed.

In one embodiment, the backpack safety device interacts with a mobile device of a user via a downloadable mobile app that can be installed on the user's mobile device. The mobile device is a smartphone, a tablet, a laptop or a desktop computer, etc., or any other suitable electronic device that has the required operating and memory parameters to support the software application of the present invention. The mobile or software application provides secure website and/or smart phone app access by users and/or parents for the backpack wearer. Typically, a cellular wireless data network embedded in the computer, tablet or smartphone, etc., is utilized to transmit information. Mobility is a key feature of the present invention. It permits flexibility. For example, if a threatening situation happens at school, the user can track the backpack safety device in real time. Thus, the software application for users and/or parents, which is accessed via a smartphone, tablet or computer, etc., locates and communicates with the wearer of the backpack safety device.

Further, the backpack safety device connects to a network, for example, by pairing with the user's mobile device or by connecting to a Wi-Fi hotspot. The data communication network enables data communication between multiple electronic devices. The network can include, for example, a local area network (LAN), a cellular phone network, a wide area network (WAN), i.e., the Internet, or a combination of them. A user device receives images and other optional information from the backpack safety device. A user device is an electronic device, or collection of devices, that is capable of requesting and receiving resources over the network. Example user systems include personal computers, mobile communication devices, and other devices that can send and receive data over the network. A user device typically includes the mobile application. Once connected via the mobile application, a user can see a live image stream from the cameras on the backpack safety device. The user can speak into a microphone and transmit audio instructions to the wearer of the backpack safety device, where speakers on the backpack safety device or the mobile device play the audio instructions.

Accordingly, the backpack safety device now makes it possible to protect parts of the user's body from harm due to ballistic shots, monitor the environment around the user and the backpack safety device, obtain photos, audio and videos from the surroundings of the backpack safety device, charge electrical devices on the go, and communicate with and track a user of the backpack safety device via the synced mobile application.

In one embodiment, the backpack safety device with shoulder straps is capable of being used on one's back, as well as being used with the backpack device covering a user's chest. The straps allow it to be carried on one's back or across one's chest, as desired.

In yet another embodiment, the backpack safety device comprises a plurality of indicia.

In yet another embodiment, a method of protecting a child by providing easily accessible safety features on a backpack device is disclosed. The method includes the steps of providing a backpack safety device comprising a body component with multiple safety features, such as cameras, a microphone, an emergency alert button, a communication button, and a mobile application. The method also comprises activating the mobile application from the backpack device. Further, the method comprises wearing the backpack safety device. Finally, the method comprises activating the safety features of the backpack safety device, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the backpack safety device of the present invention showing the cameras and a communication button in accordance with the disclosed architecture;

FIG. 2 illustrates a perspective view of one embodiment of the backpack safety device of the present invention showing the front-facing camera and speaker in accordance with the disclosed architecture;

FIG. 3 illustrates a perspective view of one embodiment of the backpack safety device of the present invention showing bullet-proof insert in accordance with the disclosed architecture;

FIG. 4 illustrates a perspective view of one embodiment of the backpack safety device of the present invention showing the backpack device and mobile application in use in accordance with the disclosed architecture;

FIG. 5 illustrates a block diagram of the wireless communication module in communication with a smart device and the backpack safety device of the present invention in accordance with the disclosed architecture; and

FIG. 6 illustrates a flowchart showing the method of protecting a child by providing easily accessible safety features on a backpack device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a backpack safety device that provides a bulletproof child's backpack with video and audio recording using a front and rear camera. There is also a long felt need in the art for a backpack safety device that includes GPS capabilities to alert parents via a mobile app of the child's location. Further, there is a long felt need in the art for a backpack safety device that enables users to contact emergency authorities and their parents with a push of the button. Moreover, there is a long felt need in the art for a device that allows parents to monitor their child in real time using the cameras and the accompanying mobile app. Further, there is a long felt need in the art for a backpack safety device that ensures that in an emergency or abduction, authorities are alerted immediately and footage of the incident exists. Finally, there is a long felt need in the art for a backpack safety device that can send Amber alerts if needed.

The present invention, in one exemplary embodiment, is a novel backpack safety device. The device is an improved backpack designed to keep children safe by providing safety features that can be easily accessed. The backpack safety device comprises a body component with a front and rear facing cameras, a microphone, a Teflon shield, an emergency alert button, and a communication button. The backpack safety device is also in wireless communication with a mobile application. The mobile application allows a user to view video from the cameras of the backpack device. The mobile application also has emergency contacts, which are notified when the communication button is pushed. The mobile application also allows a user to communicate with the user of the backpack device and can send Amber alerts if needed. The present invention also includes a novel method of protecting a child by providing easily accessible safety features on a backpack device. The method includes the steps of providing a backpack safety device comprising a body component with multiple safety features, such as cameras, a microphone, an emergency alert button, a communication button, and a mobile application. The method also comprises activating the mobile application from the backpack device. Further, the method comprises wearing the backpack safety device. Finally, the method comprises activating the safety features of the backpack safety device, as needed.

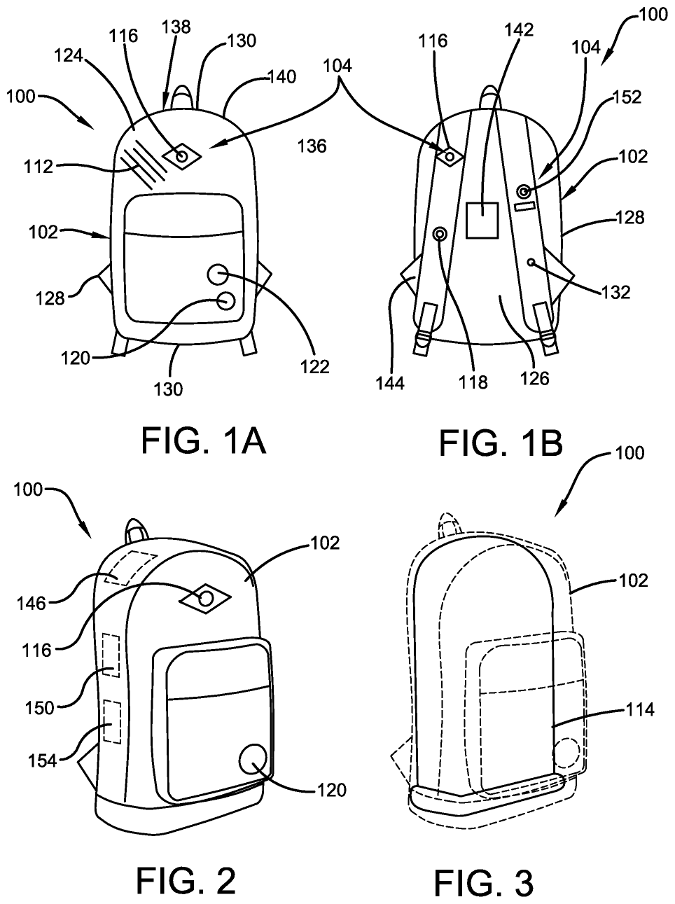

Referring initially to the drawings, FIGS. 1A-B illustrate a perspective view of one embodiment of the backpack safety device 100 of the present invention. In the present embodiment, the backpack safety device 100 is an improved backpack safety device 100 that provides a user 110 with a backpack designed to keep children safe by providing safety features that can be easily accessed. Specifically, the backpack safety device 100 comprises a body component 102 configured in the shape of a conventional backpack with a plurality of safety features 104. The backpack safety device 100 is also in wireless communication with a mobile application 106. The mobile application 106 allows a user 110 (i.e., parent/guardian) to track and communicate with the wearer/user 108 of the backpack safety device 100.

Generally, the backpack safety device 100, as disclosed, is a backpack for carrying school books by kids and travel items by travelers, wherein the backpack safety device 100 provides a Teflon shield 112 and bulletproof insert 114 and several sections for storing books and electronic items. It also provides other safety features 104, such as remote alerting and data collection capabilities based on cameras 116, communication buttons 118, speakers 120, microphone 122, and wireless communication with a mobile application 106, etc. Generally, it should be recognized that the backpack safety device 100 can incorporate a large number of different safety features 104 depending on the specifics of how the backpack is to be used. For purposes of this disclosure, the important aspect is that the backpack safety device 100 serves as a locator of the associated user 108 and will generally be used to allow the associated user 108 to contact emergency services, when needed and alert a user 110 of the mobile application 106 that a threatening situation is occurring.

Furthermore, the backpack safety device 100 comprises a body component 102 that is configured in the shape of a conventional backpack and defines a storage volume. Further, the body component 102 comprises a front panel 124, a back panel 126, opposing side walls 128, opposing top and bottom sections 130 and a set of straps 132. Further, the body component 102 can include a front pocket section 134 for storing pens, keys, tickets, etc., a front top section 136 to store small electronics, wires, cables etc., and a main section 138 with a zippered opening 140 to store laptops, tablets, powerbank chargers, etc. In one embodiment, the outer panels 124, 126 and walls 128 comprise a slash resistant material layer, such as a Teflon shield 112, or the equivalent. Thus, the items inside the backpack safety device 100 are not easy to steal by pickpockets and thieves who often try to silently make a cut or tear in the bag without the traveler/user noticing it. The body component 102 also comprises pouches to safely and securely store a mobile device, a camera, a laptop, etc.

Additionally, the backpack safety device 100 also comprises a powerbank portable charging device 142, wherein the powerbank portable charging device 142 supplies power from its built-in batteries through a plurality of ports and attached charging cables 144 (USB ports for example). Although the present invention has been described in terms of USB based power charging of devices, other forms and techniques to charge electrical devices such as mobile phones and cameras are also contemplated.

Further, in one embodiment, the backpack safety device 100 also provides a communication and location circuitry 146 that not only determines a location (such as GPS location) but also communicates backpack status, powerbank portable charging device 142 charging status, environmental conditions (such as heat, moisture, etc.) of the body component 102 status etc. Accordingly, the communication and location circuitry 146 reports the status of the backpack safety device 100, wherein the status comprises environmental conditions, the wear and tear effect/estimated, the number of ballistic shots the backpack safety device 100 may have received, the time and location of when and where such ballistic shots might have been received, approximate impact location of the ballistic shots on the backpack safety device 100, etc. Using near field communications, WIFI, infrared (IR) and cellular means, the communication and location circuitry 146 reports the overall status of the backpack safety device 100. For example, using NFC means the backpack safety device 100 reports to a mobile device 148 of the user 110 the status of the backpack safety device 100. Further, the communication and location circuitry 146 draws electrical power as necessary from the powerbank portable charging device 142 to which it is electrically and communicatively coupled.

In one embodiment, the communication and location circuitry 146 is incorporated into the back panel 126 of the body component 102 in some configurations, incorporated into the powerbank portable charging device 142 (also referred to as the powerbank charger) in other configurations, and into the construction of the backpack safety device 100 itself, in yet other configurations.

Further, the electronic circuitry of the backpack safety device 100 comprises a processor 150 communicatively coupled to the communications circuitry 146, wherein the communications circuitry 146 is capable of NFC and wifi communications for communicating data collected and streaming videos (such as those taken by a camera 116 communicatively coupled). In another embodiment, the processor 150 is communicatively and electrically coupled to the powerbank charger 142 for electrical power. The processor 150 facilitates near-field and wifi communications employing the communications circuitry 146, conducts automated and triggered mode monitoring, and data collection, as well.

In one embodiment, the backpack safety device 100 comprises an emergency alert button 152 and a communication button 118, which can be positioned at any location on the backpack safety device 100, depending on the needs and/or wants of a user. Pressing the emergency alert button 152, contacts emergency services, such as police, fire, EMT, etc. The user 108 hits the emergency alert button 152, i.e., when an attacker or threatening person approaches, in the event of a threatening situation, or when the user 108 has a health emergency. Pressing the communication button 118 allows the wearer/user 108 of the backpack safety device 100 to communicate with the user 110 of the synced mobile application 106. Further, emergency contacts can be listed, which are notified when the communication button 118 is pushed. A user 108/110 can also send Amber alerts, if needed. Furthermore, the backpack safety device 100 also comprises audio command circuitry 154 that monitors audio signals from the speakers 120 to detect commands and instructions, and upon detecting, triggers a corresponding activity, instead of having the user 108 push a button. For example the user 108 of the backpack safety device 100 may say “alert” and the backpack safety device 100 responds by detecting “alert” to be a command and initiates contacting emergency services. For a different example, other similar user commands that initiate calling a local police or fire for help, such as “danger”, “help”, “police”, etc., can be utilized, as needed.

As shown in FIG. 2, the backpack safety device 100 comprises at least one camera 116 secured to the body component 102. The cameras 116 can be positioned on the front 124 and/or the back 126 of the backpack safety device 100. The cameras 116 are built-in to capture and communicate photos, audio and live streaming videos, as necessary. Such communication from cameras 116 is through wireless means, wired means or both, based on needs and conditions. Several other locations for additional cameras 116 are also contemplated, such as cameras 116 on the backside, cameras inside, cameras on the sides, etc. Not all cameras 116 need to be active at any given time. Data collection using these cameras 116 is triggered by user actions, by voice commands by the user 108, by remote activation (i.e., mobile application 106), etc. Further, the communication and location circuitry 146 is coupled to the one or more cameras 116 attached to the backpack safety device 100 and helps communicate photos, audio data collected, and videos when the cameras 116 are activated for data collection. Such cameras 116 are attached to the front side 124, the backside 126 and other places on the backpack safety device 100, as desired. The communication and location circuitry 146 communicates GPS coordinates of the backpack safety device 100, along with data collected by these cameras 116. Data collection is triggered by monitoring circuitry in some configurations and upon user instruction in some others. The cameras 116 can be initiated by remote triggers in some configurations.

Further, the backpack safety device 100 comprises at least one speaker 120 and microphone 122, which allow the user 108 to communicate with a user 110 of a synced mobile application 106, in real time. Further, the powerbank charger 142 in the backpack safety device 100 records and stores (such as for live transmission, sharing or backup), sounds collected, photos and videos from the connected cameras 116, speakers 120 and microphone 122. The powerbank charger 142 in the backpack safety device 100 also communicates and/or stores photos and videos collected from a mobile phone 148, photos and videos from the connected camera(s) 116, and photos and videos from the connected tablet device. For example, the powerbank charger 142 comprises memory, storage and communication circuitry that enables it to receive and store all photos and videos transferred/communicated by the connected cameras 116, mobile phone 148, tablet, and camera(s) 116 that it is currently connected to. It is capable of sharing such transferred photos and videos with websites, video servers, social groups, social networks, YouTUBE network, Facebook network, etc. It is capable of uploading transferred photos and videos with Google websites, Google photos network, etc. The devices (camera, mobile phone, tablet, etc.) can then automatically delete those transferred photos and videos thereby making more memory/storage available for additional photos, data, videos, etc.

As shown in FIG. 3, the back panel 126 covers and protects the entire backside of the backpack safety device 100, end-to-end. In one embodiment, the back panel 126 comprises a bulletproof insert 114, that may be added to the interior of the body component 102. The bulletproof insert 114 comprises a main covering within which a plurality of ballistic resistance plates are provided. Together, these ballistic resistance plates protect the user of the backpack safety device 100 and a portion of the user's body covered by the backpack safety device 100 is protected from serious harm from ballistic shots. Accordingly, when worn on the backside of a user 108, the back panel 126 protects the backside of the user 108. When worn across the user's chest, the back panel 126 protects the front side of the user 108. In other embodiments, multiple bulletproof inserts 114 can be provided for the interior of the body component 102, depending on the wants and/or needs of a user.

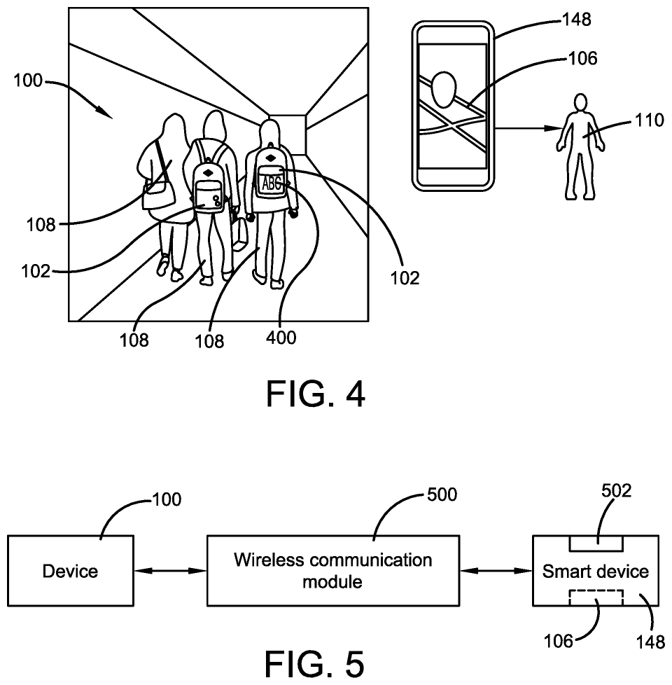

As shown in FIG. 4, the backpack safety device 100 interacts with a mobile device 148 of a user 110 via a downloadable mobile app 106 that can be installed on the user's mobile device 148. The mobile device 148 is a smartphone, a tablet, a laptop or a desktop computer, etc., or any other suitable electronic device that has the required operating and memory parameters to support the software application 106 of the present invention. The mobile or software application 106 provides secure website and/or smart phone app access by users 110 and/or parents for the backpack user 108. Typically, a cellular wireless data network embedded in the computer, tablet or smartphone, etc., is utilized to transmit information. Mobility is a key feature of the present invention. It permits flexibility. For example, if a threatening situation happens at school, the user 110 can track the backpack safety device 100 in real time. Thus, the software application 106 for users 110 and/or parents, which is accessed via a smartphone 148, tablet or computer, etc., locates and communicates with the user 108 of the backpack safety device 100.

Further, the backpack safety device 100 connects to a network, for example, by pairing with the user's mobile device 148 or by connecting to a Wi-Fi hotspot. The data communication network enables data communication between multiple electronic devices. The network can include, for example, a local area network (LAN), a cellular phone network, a wide area network (WAN), i.e., the Internet, or a combination of them. A user device 148 receives images and other optional information from the backpack safety device 100. A user device 148 is an electronic device, or collection of devices, that is capable of requesting and receiving resources over the network. Example user systems include personal computers, mobile communication devices, and other devices that can send and receive data over the network. A user device 148 typically includes the mobile application 106. Once connected via the mobile application 106, a user 110 can see a live image stream from the cameras 116 on the backpack safety device 100. The user 110 can speak into a microphone and transmit audio instructions to the user 108 of the backpack safety device 100, where speakers 120 on the backpack safety device 100 or the mobile device 148 play the audio instructions.

Accordingly, the backpack safety device 100 now makes it possible to protect parts of the user's body from harm due to ballistic shots, monitor the environment around the user 108 and the backpack safety device 100, obtain photos, audio and videos from the surroundings of the backpack safety device 100, charge electrical devices on the go, and communicate with and track a user 108 of the backpack safety device 100 via the synced mobile application 106.

Further, the backpack safety device 100 with shoulder straps 132 is capable of being used on one's back, as well as being used with the backpack device 100 covering a user's chest. The straps 132 allow it to be carried on one's back or across one's chest, as desired.

In yet another embodiment, the backpack safety device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be backpack, safety, or brand related.

FIG. 5 illustrates a block diagram of the wireless communication module 500 in communication with a smart device 148 and the backpack safety device 100 of the present invention. The backpack safety device 100 includes a wireless communications module 500 and additional sensors 502 which would allow the device 100 to pair with a mobile application 106 on a smart device 148. Once paired, a user 110 could track and communicate with the backpack safety device 100 via the mobile application 106.

As one of ordinary skill in the art will appreciate, the terms “connected” and “electrically connected,” as may be used herein, include direct coupling and indirect coupling via another component, element, circuit, or module where, for indirect coupling, the intervening component, element, circuit, or module does not modify the charging function but may adjust its current level, voltage level, and/or power level.

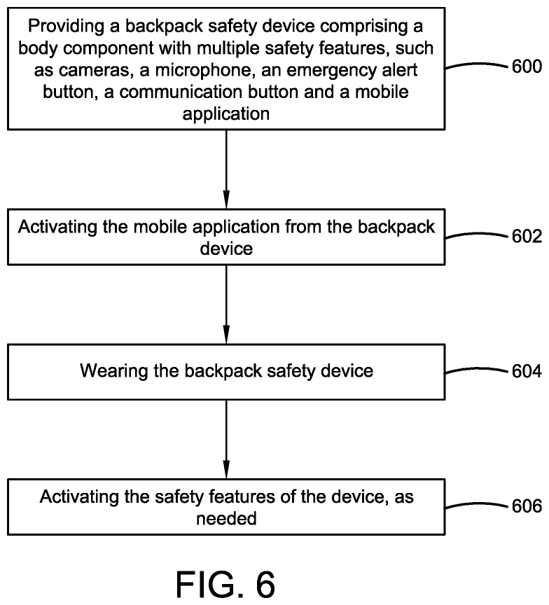

FIG. 6 illustrates a flowchart of the method of protecting a child by providing easily accessible safety features on a backpack device. The method includes the steps of at 600, providing a backpack safety device comprising a body component with multiple safety features, such as cameras, a microphone, an emergency alert button, a communication button, and a mobile application. The method also comprises at 602, activating the mobile application from the backpack device. Further, the method comprises at 604, wearing the backpack safety device. Finally, the method comprises at 606, activating the safety features of the backpack safety device, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “backpack safety device”, “backpack device”, “safety device”, and “device” are interchangeable and refer to the backpack safety device 100 of the present invention.

Notwithstanding the forgoing, the backpack safety device 100 of the present invention can be of any suitable size and configuration as is known in the art without affecting the overall concept of the invention, provided that it accomplishes the above stated objectives. One of ordinary skill in the art will appreciate that the backpack safety device 100 as shown in FIGS. 1-6 is for illustrative purposes only, and that many other sizes and shapes of the backpack safety device 100 are well within the scope of the present disclosure. Although the dimensions of the backpack safety device 100 are important design parameters for user convenience, the backpack safety device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A backpack safety device that keeps children safe by providing safety features that can be easily accessed, the backpack safety device comprising:
a body component configured in a shape of a conventional backpack; and
a plurality of safety features;
wherein the backpack safety device is in wireless communication with a mobile application;
wherein the mobile application and the plurality of safety features allow for remote data collection and emergency services alerts; and
wherein the mobile application allows a user to track and communicate with a user of the backpack safety device in real time.

2. The backpack safety device of claim 1, wherein the body component defines a storage volume and comprises a front panel, a back panel, opposing side walls, opposing top and bottom sections and a set of straps.

3. The backpack safety device of claim 2, wherein the front panel, the back panel, and the opposing side walls comprise a slash resistant material layer, such as a Teflon shield.

4. The backpack safety device of claim 3 further comprising a powerbank portable charging device, wherein the powerbank portable charging device supplies power from its built-in batteries to the plurality of safety features.

5. The backpack safety device of claim 4 further comprising a communication and location circuitry that not only determines a GPS location but also communicates backpack safety device status, powerbank portable charging device status, and environmental conditions of the body component status, using near field communications, WIFI, infrared (IR) and cellular means to the mobile application.

6. The backpack safety device of claim 5 further comprising a processor communicatively coupled to the communication and location circuitry for monitoring and data collection.

7. The backpack safety device of claim 6 further comprising an emergency alert button for contacting emergency services.

8. The backpack safety device of claim 7 further comprising a communication button that allows the user of the backpack safety device to communicate with the user of the mobile application, to notify emergency contacts and send an Amber alert.

9. The backpack safety device of claim 8 further comprising audio command circuitry that monitors audio signals from speakers on the body component to detect commands and instructions, and upon detecting, trigger a corresponding activity.

10. The backpack safety device of claim 9 further comprising at least one camera secured to the body component, to capture and communicate photos, audio and live streaming videos, as necessary to the mobile application.

11. The backpack safety device of claim 10 further comprising at least one speaker and microphone, which allow the user of the backpack safety device to communicate with the user of the mobile application, in real time.

12. The backpack safety device of claim 11 further comprising at least one bulletproof insert, that may be added to an interior of the body component.

13. A backpack safety device that keeps children safe by providing safety features that can be easily accessed, the backpack safety device comprising:
a body component that defines a storage volume and comprises a front panel, a back panel, opposing side walls, opposing top and bottom sections and a set of straps;
a communication and location circuitry that not only determines a GPS location but also communicates backpack safety device status, powerbank portable charging device status, and environmental conditions of the body component status, using near field communications, WIFI, infrared (IR) and cellular means to the mobile application;
a processor communicatively coupled to the communication and location circuitry for monitoring and data collection;
an emergency alert button for contacting emergency services;
a communication button that allows a user of the backpack safety device to communicate with a user of a mobile application, to notify emergency contacts and send an Amber alert;
at least one camera secured to the body component, to capture and communicate photos, audio and live streaming videos, as necessary to the mobile application;
at least one speaker and microphone, which allow the user of the backpack safety device to communicate with the user of the mobile application, in real time;
at least one bulletproof insert, that may be added to an interior of the body component; and
a mobile application, wherein the backpack safety device is in wireless communication with the mobile application; and
wherein the mobile application allows for remote data collection and emergency services alerts; and
wherein the mobile application allows a user to track and communicate with a user of the backpack safety device in real time.

14. The backpack safety device of claim 13 further comprising a powerbank portable charging device, wherein the powerbank portable charging device supplies power from its built-in batteries to the plurality of safety features.

15. The backpack safety device of claim 13 further comprising audio command circuitry that monitors audio signals from speakers on the body component to detect commands and instructions, and upon detecting, trigger a corresponding activity.

16. The backpack safety device of claim 13, wherein the front panel, the back panel, and the opposing side walls comprise a slash resistant material layer, such as a Teflon shield.

17. The backpack safety device of claim 13 further comprising a plurality of indicia.

18. The backpack safety device of claim 13 further comprising a wireless communications module and additional sensors which would allow the backpack safety device to pair with the mobile application on a smart device.

19. The backpack safety device of claim 13, wherein once connected with the mobile application, the user of the mobile application can see a live image stream from the at least one camera on the backpack safety device, and can speak into a speaker of the smart device to transmit audio instructions to the user of the backpack safety device.

20. A method of protecting a child by providing easily accessible safety features on a backpack device, the method comprising the following steps:
providing a backpack safety device comprising a body component with multiple safety features, such as cameras, a microphone, an emergency alert button, a communication button, and a mobile application;
activating the mobile application from the backpack device;
wearing the backpack safety device; and
activating the safety features of the backpack safety device, as needed.
